(19) United States
(12) Patent Application Publication
(10) Pub. No.: US 2013/0114743 A1
(43) Pub. Date: May 9, 2013

(54) ENCODER, DECODER AND METHODS THEREOF FOR REFERENCE PICTURE MANAGEMENT

(71) Applicants: Rickard Sjöberg, Stockholm (SE); Jonatan Samuelsson, Stockholm (SE)

(72) Inventors: Rickard Sjöberg, Stockholm (SE); Jonatan Samuelsson, Stockholm (SE)

(21) Appl. No.: 13/575,421

(22) PCT Filed: Jun. 26, 2012
(86) PCT No.: PCT/SE12/50713

§ 371 Date: Jul. 26, 2012

Related U.S. Application Data
(60) Provisional application No. 61/507,388, filed on Jul. 13, 2011.

(51) Int. Cl. H04N 7/26; H04N 7/36

(52) U.S. Cl. CPC H04N 19/00903
USPC 375/240.26

(57) ABSTRACT

The embodiments of the present invention relate to reference picture management in connection with video encoding and decoding, and in particular to reference picture signalling. A method performed by an encoder for encoding a representation of a video stream of multiple pictures is provided. Each picture belongs to a layer. In the method, it is decided if any picture that belongs to a layer equal to or lower to a layer of a current picture is using the current picture as a reference picture in a decoding process, and information is sent to a decoder indicating if the current picture is not used as a reference picture by any picture belonging to the same or lower layer.

### TECHNICAL FIELD

The embodiments generally relate to reference picture management in connection with video encoding and decoding, and in particular to reference picture signalling.

### BACKGROUND

H.264, also referred to as Moving Picture Experts Group-4 (MPEG-4) Advanced Video Coding (AVC), is the state of the art video coding standard. It consists of a block based hybrid video coding scheme that exploits temporal and spatial prediction.

High Efficiency Video Coding (HEVC) is a new video coding standard currently being developed in Joint Collaborative Team-Video Coding (JCT-VC). JCT-VC is a collaborative project between MPEG and International Telecommunication Union Telecommunication standardization sector (ITU-T). Currently, a Working Draft (WD) is defined that includes large macroblocks (abbreviated LCUs for Largest Coding Units) and a number of other new tools and is more efficient than H.264/AVC.

In video transmission, a decoder of a receiver receives a bit stream representing pictures, i.e. video data packets of compressed data. The compressed data comprises payload and control information. The control information comprises e.g. information of which reference pictures should be stored in a reference picture buffer. This information is a relative reference to previously received pictures. Further, the decoder decodes the received bit stream and displays the decoded picture. In addition, the decoded pictures are stored in a reference picture buffer according to the control information. These stored reference pictures are used by the decoder when decoding subsequent pictures.

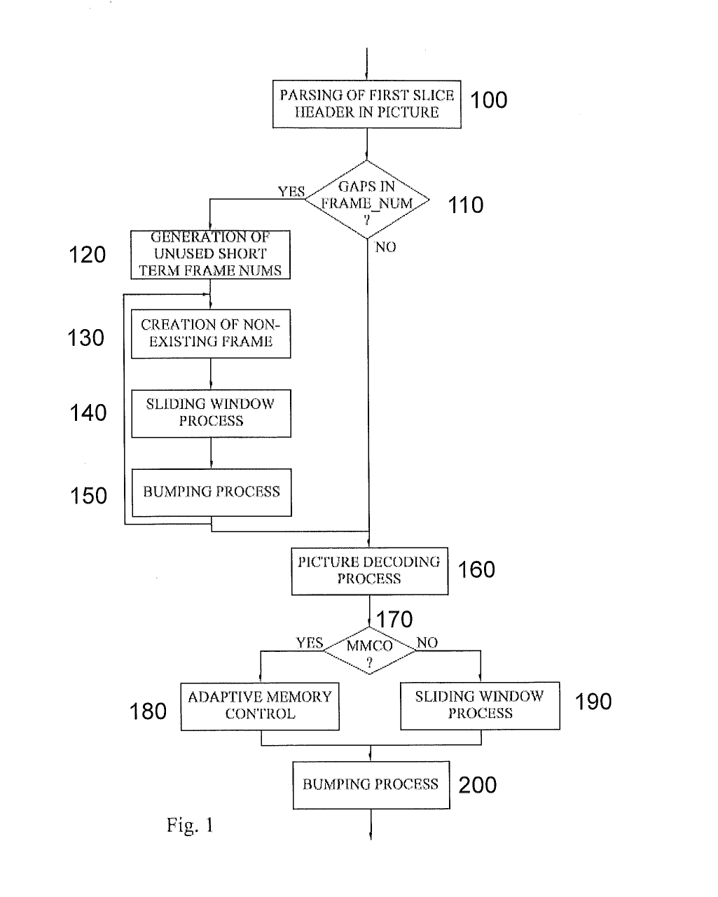

A simplified flow chart of the scheme performed at the receiver as it is designed in H.264/AVC is shown in FIG. 1. Before the actual decoding of a picture, the frame_num in the slice header is parsed 100 to detect possible gap in frame_num 110 if Sequence Parameter Set (SPS) syntax element gaps_in_frame_num_value_allowed_flag is 1. The frame_num indicates the decoding order. If a gap in frame_num is detected, “non-existing” frames are created 120, 130 and inserted into the reference picture buffer, also referred to as Decoded Picture Buffer (DPB). A sliding window process 140 and a bumping process 150 are then applied.

Regardless of whether there was a gap in frame_num or not the next step is the actual decoding 160 of the current picture. If the slice headers of the picture contain Memory Management Control Operations (MMCO) commands 170, adaptive memory control process is applied 180 after decoding of the picture to obtain relative reference to the pictures to be stored in the reference picture buffer; otherwise a sliding window process is applied 190 to obtain relative reference to the pictures to be stored in the reference picture buffer. As a final step, the “bumping” process is applied 200 to deliver the pictures in correct order.

In H.264/AVC, SVC and HEVC all encoded data is put in Network Abstraction Layer (NAL) units. The NAL unit consists of the encoded data and a NAL unit header. In the NAL unit header there is a syntax element called nal_ref_idc specifying if the picture contained in the NAL unit is a reference picture or not. This information is used in the decoding process of the current picture. Pictures with nal_ref_idc equal to 0 can not be used for reference during inter prediction of subsequent pictures, hence they are referred to as non-reference pictures. nal_ref_idc is also useful in other respects; a network node or a decoder can discard all NALs with nal_ref_idc=0 without forwarding them or decoding them and yet the resulting bitstream will be decodable since no picture is referencing the non-reference pictures.

In SVC and HEVC there is a temporal_id syntax element in the NAL unit header with information about the temporal layer of the current picture. It is defined in HEVC and SVC that a picture with temporal_id=tIdA cannot reference a picture with temporal_id=tIdB if tIdA is less than tIdB. Thus, pictures in higher temporal layers can not be used for prediction in lower temporal layers, but pictures in lower temporal layers can be used for prediction in higher temporal layers. Sometimes, in some or all pictures, depending on the coding structure, pictures in one temporal layer are used for prediction by other pictures in the same temporal layer. There are very few, if any, practical use-cases for having pictures in any other temporal layer than the highest temporal layer that are not at all used for prediction. That is, it can be assumed that all pictures in temporal layers lower than the highest temporal layer will be used for prediction by at least one picture in the same or higher temporal layers.

A sub-stream can be created from an HEVC or SVC bitstream through removal of all pictures belonging to layers higher than temporal layer T, for any chosen T. For example, if a bitstream has four temporal layers {0, 1, 2, 3}, a bitstream where the temporal layers 2 and 3 has been removed is fully decodable by an HEVC or SVC decoder.

### SUMMARY

The problem with existing solutions is that there is no possibility to mark pictures or NALs, with an indicator saying whether it is a reference picture or not in the sub-stream when the highest temporal layer(s) has (have) been removed.

Pictures must be marked as reference pictures if they are used for prediction by any picture, including pictures in higher layers. For AVC, SVC and HEVC this means that nal_ref_idc must not be equal to 0 in the NAL unit headers for pictures used as reference pictures. For non-reference pictures nal_ref_idc is equal to 0. Therefore, when a higher layer is removed and the pictures no longer are used for prediction they can be “re-marked” as non-reference pictures by changing the value of nal_ref_idc to 0, assuming that the value of non_ref_idc does not affect the decoding process. If nal_ref_idc has an impact of the decoding process, as is the case for example in H.264 and AVC, the value of nal_ref_idc can not be changed by a network node without introducing decoding errors. As stated above, for AVC, nal_ref_idc==0 means that the picture is a non-reference picture. That means that the decoded picture buffer is not updated, instead the current status is kept. If a non-reference picture is converted by a decoder to a reference picture by setting nal_ref_idc to 1, there will be a mismatch between the encoder and decoder regarding reference pictures. Thus, the re-marking is a process that changes parts of the original bitstream, a process that in many scenarios is not feasible or even possible.

Further it is generally not trivial for a decoder or a network node to deduce if a picture in a sub-stream with nal_ref_idc≠0 can be marked as non-reference by setting nal_ref_idc to 0 when a higher layer has been removed. The encoder is aware of this since it decides how to handle reference pictures. Thus, the decoder is not aware of, before the decoding of the picture, whether a layer could be safely removed. The decoder has to check future pictures to know whether a picture can be safely removed. The same is true for other network nodes, the network nodes know from the value of nal_ref_idc whether the picture is a non-reference picture for the outmost layer. But if that layer is removed, either by the network node itself or by an entity before this network node the network node will not know. Although the network performs a deeper packet inspection and keeps track of buffer states, it will not be sure whether a picture is used for reference until future frames are processed.

As an example, it is difficult for a decoder or a network node to deduce whether two highest layers can safely be removed from a bitstream in the middle of the stream. The highest layer can safely be removed if the values of nal_ref_idc of the corresponding NAL unit headers are equal to 0. But the second highest layer is generally used for predicting the highest layer and therefore has nal_ref_idc not equal to 0. Furthermore, the decoder will not know whether a second highest layer picture will be referenced by a future picture of the same layer. If it is a reference picture for a future picture in the same layer, the picture can not be removed without future decoding errors. For a network node to decide whether a picture A is used for reference or not, it must decode information from pictures following A in decoding order in order to verify that picture A is not used for reference. This includes keeping track of picture marking of future pictures and will induce latency in the node.

Thus an objective with the embodiments is to solve at least one of the problems described above.

According to a first aspect of embodiments of the present invention, a method performed by an encoder for encoding a representation of a video stream of multiple pictures is provided. Each picture belongs to a layer. In the method, it is decided if any picture that belongs to a layer equal to or lower to a layer of a current picture is using the current picture as a reference picture in a decoding process, and information is sent to a decoder indicating if the current picture is not used as a reference picture by any picture belonging to the same or lower layer.

According to a second aspect of embodiments of the present invention, a method performed by a network node receiving a coded representation of a video stream of multiple pictures is provided. Each picture belongs to a layer. In the method, information is received from an encoder indicating if a current picture is not used as a reference picture by any picture belonging to the same or lower layer.

According to a third aspect of embodiments of the present invention, an encoder for encoding a representation of a video stream of multiple pictures is provided. Each picture belongs to a layer. The encoder comprises a processor for deciding if any picture that has a layer equal or lower to a layer of a current picture is not using the current picture as a reference picture in a decoding process.

The encoder also comprises a transmitter for sending information to a decoder indicating if the current picture is not used as a reference picture by any picture in the same or lower layer.

According to a fourth aspect of embodiments of the present invention, a network node for receiving a coded representation of a video stream of multiple pictures is provided. Each picture belongs to a layer. The network node comprises a receiver for receiving information from an encoder indicating if a current picture is not used as a reference picture by any pictures in the same or lower layer.

An advantage with the embodiments is that the decoder can then choose not to decode the picture in order to reduce computational load for example and still know that it can decode the other pictures in the same layer. Hence, the decoder receives information from the encoder if a picture is a non-reference picture when layers have been removed. This means that the decoder easily can decide to not decode pictures which will not be referenced by any picture that is not removed.

### DETAILED DESCRIPTION

The embodiments described herein are explained in the context of HEVC, wherein the layers are temporal layers identified by temporal layer identifiers denoted temporal_id. However, a skilled person understands that the embodiments are also applicable on other video coding standards using a layered structure. In the description the layers are exemplified by temporal layers, but the embodiments are also applicable on other layered video coding schemes and combinations thereof, such as but not limited to spatial scalability, SNR scalability, bit-depth scalability and chroma format scalability, where pictures are associated with layers. The layers being ordered and having the property that each layer is ignorant of pictures belonging to a higher layer in the sense that each sub-stream containing the N lowest layers is always decodable.

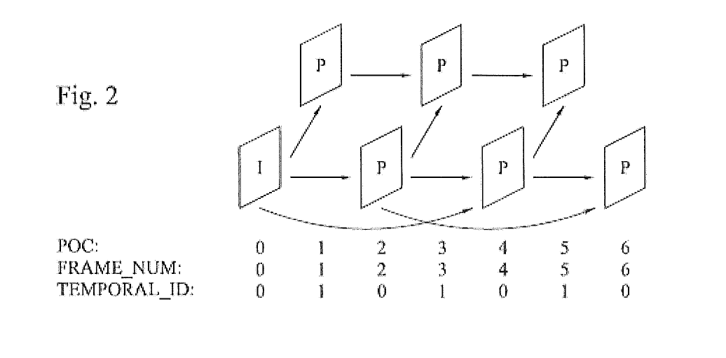

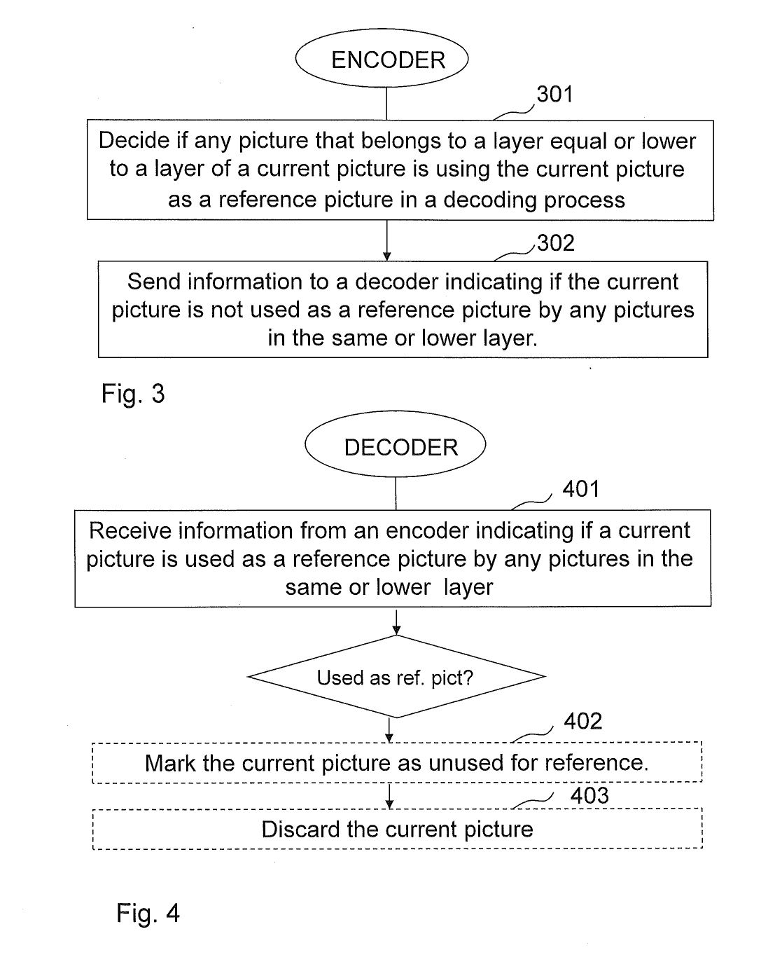

As illustrated in the flowchart of FIG. 3, a method performed in an encoder for encoding a representation of a video stream of multiple pictures, wherein each picture belongs to a layer is provided according to an embodiment.

It is decided 301 if any picture belonging to a layer equal or lower to a layer of a current picture are using the current picture as a reference picture in a decoding process, and information is sent 302 to a decoder indicating if the current picture is not used as a reference picture by any picture belonging to the same or lower layer.

That means that an encoder is configured to signal for every picture if it is a non-reference picture in the sub-stream that can be created when all layers above the layer to which the picture belongs are removed.

That is, for any picture A having a layer identity exemplified by a temporal layer identity tIdA the encoder is configured to signal if A would be a reference picture or not if all pictures with temporal layer identity higher than tIdA were removed. In other words: for any picture A having temporal layer identity tIdA the encoder is configured to signal if A is not used for reference by any other picture B with temporal layer identity tIdB such that tIdB<=tIdA. However, there may be a rule saying that any picture C can not be a reference picture to a picture D if the temporal layer of C is higher than the temporal layer of D. In this case, for any picture A having temporal layer identity tIdA the encoder is configured to signal if A is not used for reference by any other picture B with temporal layer identity tIdB such that tIdB=tIdA.

Thus, if this rule is applied, it is decided 301 if any picture that belongs to a layer equal to a layer of a current picture are using the current picture as a reference picture in a decoding process, and information is sent 302 to a decoder indicating if the current picture is not used as a reference picture by any picture belonging to the same layer.

In one embodiment of the invention the usage of a syntax element nal_ref_idc in the NAL unit header is changed so that it no longer indicates that the picture that is encoded in the NAL is unconditionally not used for prediction. Instead it is used to indicate that the picture is not used for prediction by pictures with the same temporal id also referred to as temporal_id, or lower temporal identity, which implies that the information sent to the decoder indicates if the current picture is not used as a reference picture by any pictures in the same or lower layer. However, if there is a rule stating that a picture is forbidden to use reference pictures from a higher layer, it is used to indicate that the picture is not used for prediction by pictures in the same layer e.g. with the same temporal_id.

In an alternative embodiment, the syntax element nal_ref_idc is defined such that one of its values indicates that the picture that is encoded in the NAL is not used for prediction by pictures having the same or lower temporal id, which implies that the information sent to the decoder indicates if the current picture is not used as a reference picture by any pictures in the same or lower layer.

However, as stated above, there may be a rule stating that a picture is forbidden to use reference pictures from a higher layer. In that case, nal_ref_idc is defined such that one of its values indicates that the picture that is encoded in the NAL is not used for prediction by pictures in the same layer e.g. pictures having the same temporal_id.

Another value of nal_ref_idc could be used to signal that the encoded picture is a non-reference picture. Other values of nal_ref_idc could signal that the encoded picture is a reference picture and the different nal_ref_idc values could be used to indicate an order of NAL priority.

In line with the conventional definition of reference pictures, nal_ref_idc=0 may mean that the picture is not used for prediction by any other picture with the same temporal_id. nal_ref_idc=1 may mean that the picture may be used for prediction by pictures with the same temporal_id.

In one embodiment of the invention a decoder is operating at a certain layer, exemplified by temporal layer T referred to as temporal_id T, meaning that pictures with temporal_id lower than or equal to T are decoded and pictures with temporal_id higher than T are not decoded at all. The pictures with higher temporal_id do not enter the decoder and seen from the decoder, these pictures do not exist. In such a process, signaling of the information that a picture is not used for prediction by other pictures in the same temporal layer according to embodiments makes the picture individually discardable if it belongs to the highest temporal layer. Also, this yields the normative process of marking such a picture as unused for reference.

It should be noted that the embodiments of the invention are not limited to the case where all layers, e.g. temporal layers, above a picture A are removed to create a sub-stream. Information about if A is used for reference by pictures with the same temporal_id might be useful in a sub-stream that contains some or all pictures from the original stream with temporal_id higher than the temporal_id of A for example in decoding resource management and parallelization.

In an alternative embodiment of the invention another syntax element is added to the NAL unit header so that the definition of nal_ref_idc does not need to be changed. Thus, this added syntax element carries the information sent to the decoder, wherein the information indicates if the current picture is not used as a reference picture by any pictures in the same or lower layer. The added syntax element can be used in the process of changing the value of nal_ref_idc, alternatively the added syntax element can be used directly by a network node or decoder.

In an alternative embodiment of the invention the signalling of said information indicates if the current picture is not used as a reference picture by any pictures in the same or lower layer. This is not done in the NAL unit header but may be done in any suitable data structure including but not limited to slice header, slice parameter set, picture header or picture parameter set.

It should be noted that nal_ref_idc has the same purpose as nal_ref_flag concerning the indication of whether a picture is used as a reference picture. Nal_ref_flag is used in HEVC while nal_ref_idc is used in H.264. Accordingly, nal_ref_flag equal to 1 may specify that the content of the NAL unit contains a sequence parameter set, a picture parameter set, an adaptation parameter set or a slice of a picture that may be included in the reference picture set of a picture of the same temporal layer. Further, nal_ref_flag equal to 0 for a NAL unit containing a slice may indicate that the slice is part of a picture that is not included in the reference picture set of any other picture of the same temporal layer.

The encoded representation performed by the encoder is sent to a network node, which may be an intermediate node in the network or a decoder for decoding the encoded representation. Hence, a method performed by a network node receiving a coded representation of a video stream of multiple pictures, wherein each picture belongs to a layer is also provided as illustrated in FIG. 4. As mentioned above, the network node may be a decoder of e.g. a device such as a mobile device, TV set or a network node in a network. The network node does not have to decode the entire picture, it is only required that the network node is able to decode control information e.g. in the NAL unit header and higher layer syntax. The network node does not have to be able to decode the pixel values of the picture.

In the decoder, information is received 401 from the encoder indicating if a current picture is not used as a reference picture by any pictures belonging to the same or lower layer, and if the current picture is not used as a reference picture by any picture belonging to the same or lower layer the current picture can be individually discardable if it belongs to the highest layer. Further, the current picture may be marked 402 as unused for reference.

According to an embodiment, the received information from the encoder indicates if a current picture is not used as a reference picture by any pictures belonging to the same layer, and if the current picture is not used as a reference picture by any picture belonging to the same layer the current picture is individually discardable if it belongs to the highest layer. Further, the current picture may be marked as unused for reference.

An advantage with the embodiments of the present invention is that it is possible to indicate in a bitstream which pictures that will not be referenced in a sub-stream created from the original bitstream by removal of temporal layers without having to make changes to values in the original bitstream. This means that the network node can easily be certain whether a picture P in layer N can be removed from the bitstream or not, where N is any layer and all pictures following picture P in decoding order in layers above N are removed.

In one embodiment the information from the encoder is used in the network node to decide if a picture can be removed from the bitstream without introducing decoding errors. The network node is configured to decide how many layers it wishes to forward and consequently what layers is wishes to remove from the stream. The network node parses the received information and the temporal_id of a packet to determine whether it is possible to remove the picture or not.

Accordingly, the current picture may be discarded 403 if the received information indicates that the current picture is not used as a reference picture by any picture in the same or lower layer and the current picture belongs to the highest layer received. If the network node is an intermediate network node, this implies that the received information is not forward to the decoder.

The encoder may also be configured to choose to encode a sequence of pictures using temporally layered coding. To enable simplified network adaptation it selects a coding structure that is suitable for adaptation in the form of removing layers in network nodes. The encoder may therefore be configured to indicate for each picture P whether picture P is used for reference in future pictures or not for future pictures of the same layer.

In an alternative embodiment of the invention, the video codec is a multiview video codec and the layer identity is a view_id. This implies that view_id is replacing temporal_id in the description above. Correspondingly, the layers are views in this alternative.

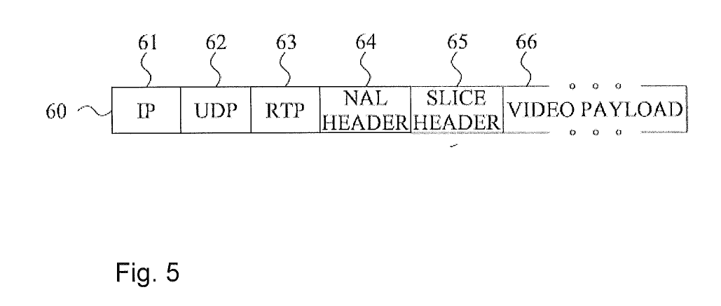

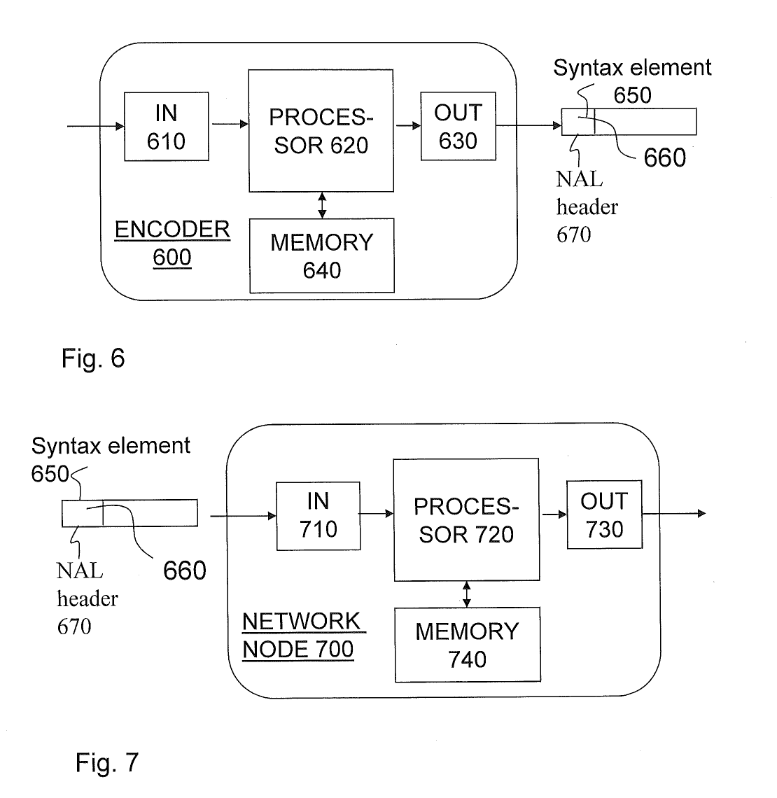

As mentioned above the information 660 regarding if a current picture is used as a reference picture by any pictures in the same or lower layer is signaled in a syntax element 650 as illustrated in FIGS. 6 and 7, and the syntax element 650 is encoded by the encoder and decoded by the decoder. As mentioned above, the syntax element 650 can be carried in a NAL header 670 and the syntax element is in some embodiment exemplified by nal_ref_idc=0. FIG. 5 schematically illustrates an example of an encoded representation 60 of a picture. The encoded representation 60 comprises video payload data that represents the encoded pixel data of the pixel blocks in a slice. The encoded representation 60 also comprises a slice header 65 carrying control information. The slice header 65 forms together with the video payload and a Network Abstraction Layer (NAL) header 64 a NAL unit that is the entity that is output from an encoder. To this NAL unit additional headers, such as Real-time Transport Protocol (RTP) header 63, User Datagram Protocol (UDP) header 62 and Internet Protocol (IP) header 61, can be added to form a data packet that can be transmitted from the encoder to the decoder.

Accordingly, an encoder 600 for encoding a representation of a video stream of multiple pictures, wherein each picture is associated with a layer is provided as illustrated in FIG. 6. The encoder 600 comprises a processor 620 for deciding if any picture that has a layer equal or lower to a layer of a current picture is not using the current picture as a reference picture in a decoding process, and a transmitter 630 for sending information 660 to a decoder indicating if the current picture is not used as a reference picture by any pictures in the same or lower layer. Further, the encoder 600 may also comprise a receiver for receiving 610 pictures to be encoded and a memory 640 for storing information required in the coding process such as information associated with reference picture handling.

According to an embodiment, there is a rule stating that a picture is forbidden to use reference pictures from a higher layer and the processor 620 is configured to decide if no picture that has a layer equal to a layer of a current picture is using the current picture as a reference picture in a decoding process. Further, the transmitter 630 is configured to send information 660 to a decoder 700 or another network node indicating if the current picture is not used as a reference picture by any pictures in the same layer.

The encoder may be an HEVC encoder or any other video encoder using a layered structure as explained herein.

Thus a network node 700 receiving a coded representation of a video stream of multiple pictures, wherein each picture is associated with a layer is provided. The network node 700 comprises a receiver 710 for receiving information 660 from an encoder indicating if a current picture is used as a reference picture by any pictures in the same or lower layer, and a processor 720 configured to mark the current picture as unused for reference if the current picture is not used as a reference picture by any picture in the same or lower layer. Further, the network node 700 may also comprise a transmitter for transmitting decoded pictures to a display and a memory for storing information required in the coding process such as information associated with reference picture handling.

In one embodiment, the processor 720 is further configured to discard the current picture if the received information indicates that the current picture is not used as a reference picture by any picture in the same or lower layer.

According to an embodiment, the received information from the encoder 600 concerns if a current picture is used as a reference picture by any pictures in the same layer, and if the current picture is not used as a reference picture by any picture in the same layer the processor 720 may be configured to mark the current picture as unused for reference. Moreover, in this case, the processor may further be configured to discard the current picture if the received information indicates that the current picture is not used as a reference picture by any picture in the same layer.

It should be noted that if the network node is an intermediate network node, the network node preferably discards the current picture if the received information indicates that the current picture is not used as a reference picture by any picture in the same layer. If the network node is a decoder of a device (any media device) displaying the current picture of a video stream, the network node can also mark the current picture. The network node may be a decoder and/or a network node which may be compliant to HEVC.

1. A method performed by an encoder for encoding a representation of a video stream of multiple pictures, wherein each picture belongs to a layer,
the method comprises:
deciding if any picture that belongs to a layer equal to or lower to a layer of a current picture is using the current picture as a reference picture in a decoding process, and
sending information to a decoder indicating whether the current picture is not used as a reference picture by any picture belonging to the same or lower layer.

2. The method according to claim 1, comprising:
deciding if any picture that belongs to the layer equal to the layer of the current picture is using the current picture as a reference picture in a decoding process, and
sending information to the decoder indicating whether the current picture is not used as a reference picture by any picture belonging to the same layer.

3. The method according to claim 1, wherein the information is sent in a NAL header.

4. The method according to claim 3, wherein the information is sent to the decoder in a syntax element in the NAL header.

5. The method according to claim 4, wherein the information is sent to the decoder in a nal_ref_idc of the NAL header.

6. The method according to claim 1, wherein the information is sent to the decoder in any of a slice header, a slice parameter set, a picture header or a picture parameter set.

7. The method according to claim 1, wherein the layer is any of temporal layer, spatial or view layer.

8. A method performed by a network node receiving a coded representation of a video stream of multiple pictures, wherein each picture belongs to a layer, the method comprising:
receiving information from an encoder indicating whether a current picture is not used as a reference picture by any picture belonging to the same or lower layer.

9. The method according to claim 8, further comprising in to the current picture not being used as a reference picture by any picture belonging to the same or lower layer by marking the current picture as unused for reference.

10. The method according to claim 8, comprising the further step of:
discarding the current picture in response to the received information indicating that the current picture is not used as a reference picture by any picture in the same or lower layer and belongs to the highest layer.

11. The method according to claim 9, wherein the received information from the encoder indicates whether a current picture is not used as a reference picture by any picture in the same layer, and further comprising responding to the current picture not being used as a reference picture by any picture in the same layer by marking the current picture as unused for reference.

12. The method according to claim 11, comprising the further step of:
discarding the current picture if the received information indicates that the current picture is not used as a reference picture by any picture in the same layer and belongs to the highest layer.

13. The method according to claim 8, wherein the information is received by the network node in a NAL header.

14. The method according to claim 13, wherein the information is received by the network node in a syntax element in the NAL header.

15. The method according to claim 14, wherein the information is received by the network node in a nal_ref_flag of the NAL header.

16. The method according to claim 8, wherein the information is received by the network node in any of a slice header, a slice parameter set, a picture header or a picture parameter set.

17. The method according to claim 8, wherein the layer is any of temporal layer, spatial or view layer.

18. An encoder for encoding a representation of a video stream of multiple pictures, wherein each picture belongs to a layer, the encoder comprises:
a processor for deciding if any picture that has a layer equal or lower to a layer of a current picture is not using the current picture as a reference picture in a decoding process, and
a transmitter for sending information to a decoder indicating whether the current picture is not used as a reference picture by any picture in the same or lower layer.

19. The encoder according to claim 18, wherein:
the processor is configured to decide if any picture that has a layer equal to a layer of a current picture is not using the current picture as a reference picture in a decoding process, and
the transmitter is configured to send information to a decoder indicating whether the current picture is not used as a reference picture by any pictures in the same layer.

20. The encoder according to claim 18, wherein the transmitter is configured to send the information in a NAL header.

21. The encoder according to claim 20, wherein the transmitter is configured to send the information in a syntax element in the NAL header.

22. The encoder according to claim 21, wherein the transmitter is configured to send the information in a nal_ref_idc of the NAL header.

23. The encoder according to claim 18, wherein the transmitter is configured to send the information in any of a slice header, a slice parameter set, a picture header or a picture parameter set.

24. The encoder according to claim 18, wherein the encoder is a High Efficient Video Coding, HEVC, encoder.

25. A network node receiving a coded representation of a video stream of multiple pictures, wherein each picture belongs to a layer, the network node comprises:
a receiver for receiving information from an encoder indicating whether a current picture is not used as a reference picture by any pictures in the same or lower layer.

26. The network node according to claim 25, further comprising:
a processor configured to mark the current picture as unused for reference in response to the information indicating that the current picture not being used as a reference picture by any picture in the same or lower layer.

27. The network node according to claim 25, wherein the processor is further configured to discard the current picture if the received information indicates that the current picture is not used as a reference picture by any picture in the same or lower layer.

28. The network node according to claim 25, wherein the received information from the encoder indicates whether a current picture is not used as a reference picture by any pictures in the same layer, and whether the current picture is not used as a reference picture by any picture in the same layer the processor is configured to mark the current picture as unused for reference.

29. The network node according to claim 25, wherein the processor is further configured to discard the current picture if the received information indicates that the current picture is not used as a reference picture by any picture in the same layer.

30. The network node according to claim 25, wherein the information is received in a NAL header.

31. The network node according to claim 30, wherein the information is received in a syntax element in the NAL header.

32. The network node according to claim 31, wherein the information is received in a nal_ref_flag of the NAL header.

33. The network node according to claim 25, wherein the information is received in any of a slice header, a slice parameter set, a picture header or a picture parameter set.

34. The network node according to claim 25, wherein the network node is a decoder component of a device.

35. The network node according to claim 24, wherein the network node is an intermediate network node.

36. The network node according to claim 24, wherein the network node is compliant to High Efficient Video Coding.
